(19) United States
(12) Patent Application Publication
(10) Pub. No.: US 2014/0299434 A1
(43) Pub. Date: Oct. 9, 2014

(54) MAGNETO RHEOLOGICAL CLUTCH

(71) Applicant: ENGINETICS, LLC, Miami Beach, FL (US)

(72) Inventors: Joseph Lull, South Haven, MI (US); Marco Peters, Ludenscheid (DE); Justin Warner, Milford, MI (US)

(73) Assignee: Enginetics, LLC, Miami Beach, FL (US)

(21) Appl. No.: 13/857,928

(22) Filed: Apr. 5, 2013

(51) Int. Cl. F16D 37/00

(52) U.S. Cl. CPC F16D 37/008
USPC 192/21.5

(57) ABSTRACT

A clutch assembly includes an input shaft, an output shaft, at least one first friction plate mounted to the input shaft, and at least one second friction plate mounted to the output shaft and spaced apart from the at least one first friction plate. The clutch assembly also includes a rheological fluid positioned between the at least one first friction plate and the at least one second friction plate, and a fluid activator configured to increase a viscosity of the rheological fluid to provide increased torque transfer from the at least one first friction plate to the at least one second friction plate.

### TECHNICAL FIELD

The present disclosure is directed to clutch systems, and more particularly relates to rheological clutches and clutch systems.

### BACKGROUND

Conventional clutches are designed to control torque throughput in a binary regimen (i.e., on and off). Clutch engagement is generally accomplished by applying force to the drive element which presses the drive element against the driven element to transfer torque therebetween. When torque is modulated by regulating the amount of force the drive element exerts against the driven element, rotational slip occurs between communicating friction surfaces of the drive and driven elements. Modulating torque results in heavy component wear, heat generation and potentially catastrophic damage.

Opportunities exist for improving clutch designs to avoid these and other drawbacks associated with existing clutch designs.

### SUMMARY

The principles described herein may address some of the above-described deficiencies and others. One aspect provides a clutch assembly including an input shaft, an output shaft, at least one first friction plate mounted to the input shaft, and at least one second friction plate mounted to the output shaft and spaced apart from the at least one first friction plate. The clutch assembly also includes a rheological fluid positioned between the at least one first friction plate and the at least one second friction plate, and a fluid activator configured to increase a viscosity of the rheological fluid to provide increased torque transfer from the at least one first friction plate to the at least one second friction plate.

The clutch assembly may include a housing having an internal cavity, wherein the at least one first friction plate, at least one second friction plate, and rheological fluid are positioned in the internal cavity. The at least one first friction plate and at least one second friction plate may include a plurality of surface friction features. The plurality of surface friction features may include a plurality of projections. The plurality of surface friction features may include a plurality of recesses. The plurality of surface friction features may include a plurality of concentric rings. The plurality of surface friction features may be arranged symmetrically relative to each other on a given friction plate. The plurality of surface friction features may be spaced apart circumferentially and radially on at least some of the first and second friction plates. The plurality of surface friction features may be formed by at least one of embossing, rolling, casting and machining. The plurality of surface friction features may increase a surface area of the at least one first friction plate and the at least one second friction plate.

The fluid activator may include a magnet and the rheological fluid may include a plurality of magnetic particles. The fluid activator may include an electrode configured to electrically charge the rheological fluid. The at least one first friction plate may include a plurality of first friction plates grounded together along peripheral edges thereof. The at least one first friction plate may be connected to the input shaft with a splined connection, and the at least one second friction plate may be connected to the output shaft with a splined connection.

Another aspect of the present disclosure relates to a clutch assembly including at least one first friction plate, at least one second friction plate, and a volume of fluid. The at least one first friction plate includes a first primary surface and a plurality of first friction features formed in the first primary surface. The at least one second friction plate includes a second primary surface and a plurality of second friction features formed in the second primary surface, wherein a space is defined between the first and second primary surfaces. The volume of fluid is retained in the space and has a variable viscosity. The volume of fluid, when energized, increases torque transfer from the at least one first friction plate to the at least one second friction plate.

The clutch assembly may include one of a magnet and an electrode configured to energize the volume of fluid. The at least one first friction plate may include a single plate having a plurality of first concentric rings extending from the first primary surface as the plurality of first friction features. The at least one second friction plate may include a single plate having a plurality of second concentric rings extending from the second primary surface as the plurality of second friction features. The plurality of first and second concentric rings may be arranged radially spaced apart from each other and at least partially overlapping in an axial direction.

The at least one first friction plate may include a plurality of first friction plates, and the at least one second friction plate may include a plurality of second friction plates interposed between the plurality of first friction plates. The clutch assembly may include an input shaft connected to the at least one first friction plate and configured to be coupled to a first torque source, and an output shaft connected to the at least one second friction plate and configured to be coupled to a second torque source.

Another aspect of the present disclosure relates to a method of controlling torque transfer. The method includes providing a clutch assembly having input and output shafts, at least one first friction plate connected to the input shaft, at least one second friction plate connected to the output shaft and spaced apart from the at least one first friction plate, and a rheological fluid positioned between the at least one first friction plate and the at least one second friction plate. The method also includes rotating the at least one first friction plate relative to the at least one second friction plate, and energizing the rheological fluid to increase a viscosity of the rheological fluid to increase torque transfer from the input shaft to the output shaft via the first and second friction plates.

The at least one first friction plate and the at least one second friction plate may include a plurality of friction features configured to create increased surface friction with the rheological fluid. The method may include providing at least one of a magnet and an electrode, and energizing the rheological fluid may include activating the magnet or electrode. The method may include providing a torque source coupled to the input shaft and a compressor coupled to the output shaft, operating the torque source, and energizing the rheological fluid to transfer torque from the torque source to the output shaft to apply torque to the compressor. The method may include arranging the at least one first friction plate and at least one second friction plate radially and concentrically.

### BRIEF DESCRIPTION OF THE DRAWINGS

The accompanying drawings illustrate certain embodiments discussed below and are a part of the specification.

FIGS. 1 and 2 are perspective views of an example clutch assembly in accordance with the present disclosure.

FIGS. 3A and 3B are cross-sectional views of the clutch assembly of FIG. 1 taken along cross-section indicators 3A,3B-3A,3B with the clutch in de-energized and energized states, respectively.

FIG. 3C is a detailed view of a portion of the cross-section shown in FIG. 3A.

FIG. 4 is an exploded perspective view of the clutch assembly of FIG. 1.

FIGS. 5A and 5B are front and side views, respectively, of an alternative friction plate design for use in the clutch assembly of FIG. 1.

FIGS. 6A and 6B are front and side views, respectively, of another example friction plate design for use in the clutch assembly of FIG. 1.

FIGS. 7A and 7B are front and side views, respectively, of another example friction plate design for use in the clutch assembly of FIG. 1.

FIGS. 8A and 8B are front and side views, respectively, of another example friction plate design for use in the clutch assembly of FIG. 1.

FIGS. 9 and 10 are perspective views of another example clutch assembly in accordance with the present disclosure.

FIGS. 11A and 11B are cross-sectional views of the clutch assembly of FIG. 9 taken along cross-section indicators 11A,11B-11A,11B.

FIG. 11C is a detailed view of a portion of the cross-section shown in FIG. 11A.

FIG. 12 is an exploded perspective view of the clutch assembly of FIG. 9.

FIG. 12A is a close up view of a portion of a friction plate of the clutch assembly shown in FIG. 12.

FIGS. 13 and 14 show the clutch assembly of FIG. 9 mounted to a two-stage hybrid compressor assembly in accordance with the present disclosure.

FIG. 15 is an exploded perspective view of the compressor assembly of FIG. 13.

FIG. 16 is a front view of the compressor assembly of FIG. 13.

FIG. 17 is a cross-sectional view of the compressor assembly of FIG. 13 taken along cross-section indicators 17-17.

Throughout the drawings, identical reference characters and descriptions indicate similar, but not necessarily identical elements.

### DETAILED DESCRIPTION

Illustrative embodiments and aspects are described below. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present disclosure is directed to rheological clutches and related clutch system. One application for such clutches and clutch systems is a fixed or variable speed, flow rate controlled compressor, such as the compressors disclosed in U.S. patent application Ser. No. 13/857,918, filed on 5 Apr. 2013, and entitled “Hybridized Compressor,” which application is incorporated herein in its entirety by this reference [the 46265.0131 application]. The compressor may be used to supply compressed air or other oxidant to a fuel preparation system, such as a dual fluid fuel injection system. The compressor may be driven by one of two torque sources and is configured to switch between the two torque sources on command. In one example, one torque source is an electric motor packaged with the compressor components. The second torque source may be an engine driven motor, which operates the compressor remotely via, for example, a belt and pulley drive system. The clutch system of the present disclosure may be operatively coupled between the first and second torque sources (e.g, between an electric motor and engine drive mechanical motor). An example dual fluid injection system and related methods, which may use the flow of compressed air generated by the compressor, is disclosed in U.S. Patent Publication No. 2011/0284652, which application is incorporated herein in its entirety by this reference.

A basic clutch typically consists of drive and driven elements as discussed above. Mechanical clutches utilize friction plates or pads, which are pulled or pressed into communication by an electromagnet. This method of actuation places the drive and driven elements into physical contact at full rotational speed and torque. The physical contact generates heat and friction that reduces a useful life of the clutch and results in other detrimental effects.

In rheological clutches, the drive and driven elements are enclosed in chambers filled with a rheological fluid. A rheological fluid contains small magnetic particles, which when energized, increase an effective viscosity of the fluid. The rheological fluid is energized either magnetically with a field generated around the drive and driven elements, or directly by passing an electrical current through the rheological fluid between the drive and driven elements. Other methods may be possible to energize the rheological fluid. When energized, the rheological fluid's effective viscosity is increased, causing torque to pass from the drive element to the driven element. Rheological fluid clutches may provide progressive engagement, through slip, which essentially yields a variable speed, and thus variable flow compressor output when the clutch is used with one of the compressor assemblies disclosed herein. Heat generated by working the viscous fluid is not the consequence of direct component interface, therefore wear and subsequent damage may be limited. The rheological fluid may interact with a heat exchanger to provide thermal management and increase life of the fluid and torque control components.

Rheological clutches may be employed as alternatives to a standard friction clutch. In the application of a compressor assembly as described herein, rheological clutches may act as or at least operate with variable speed or torque devices due to their ability to be gradually, partially charged, which allows a speed or torque differential between the drive and driven elements.

A rheological clutch may be integrated into the pulley of a mechanical or engine driven input side of a compressor assembly. Energizing the clutch mechanism moves a friction plate attached to the rotating shaft of the compressor against the engine belt driven pulley and connects the compressor to the running engine. Torque is transferred from the belt to the pulley and into the compressor shaft so that the compressor may continue rotation. The clutch may be actuated to transfer rotation of the pulley to rotation of the compressor shaft after turning off the electric motor of the compressor assembly.

A magneto-rheostatic (rheological) clutch may be employed to operatively connect the mechanical (e.g., engine driven) torque source to the compressor. Energizing an electromagnet situated around a closed volume of magneto-rheological fluid in which input and output torque elements are arranged such that when the magneto-rheological fluid is energized, the viscosity of the fluid is increased. The increased viscosity causes the input drive element to transfer torque through the fluid to the output drive element and to the compressor. The output drive of the magneto-rheostatic clutch is attached to the rotating shaft of the compressor against the engine belt driven pulley and connects the compressor to the running engine. This torque is transferred from the belt to the pulley, into the magneto-rheostatic clutch, and then to the compressor shaft. The compressor components are rotated by the compressor shaft to generate compressed air.

An electro-rheostatic (rheological) clutch may be similar to the magneto-rheostatic clutch with the primary difference being how the fluid is energized. An electrical voltage may be passed through the rheological fluid, thus charging the fluid particles. As the charge in the particles is increased, the effective viscosity of the fluid increases, thereby causing torque to be transferred from the drive element to the driven element. The mechanical function of the drive is the same as the magneto-rheological clutch, with the exception being the charging, or control, of the rheological fluid. The rheological fluid may be directly communicated with control electrodes. An electrical current is passed through the rheological fluid to modulate the viscosity, thus controlling clutch engagement and torque throughput.

Alternative geometries for rheological clutch torque input and drive elements can be optimized for increased torque control or transfer and/or improved packaging. This innovation addresses options for parallel rotor and stator plates and introduces a concentric rotor and stator configuration, which may reduce overall package length as well as component complexity.

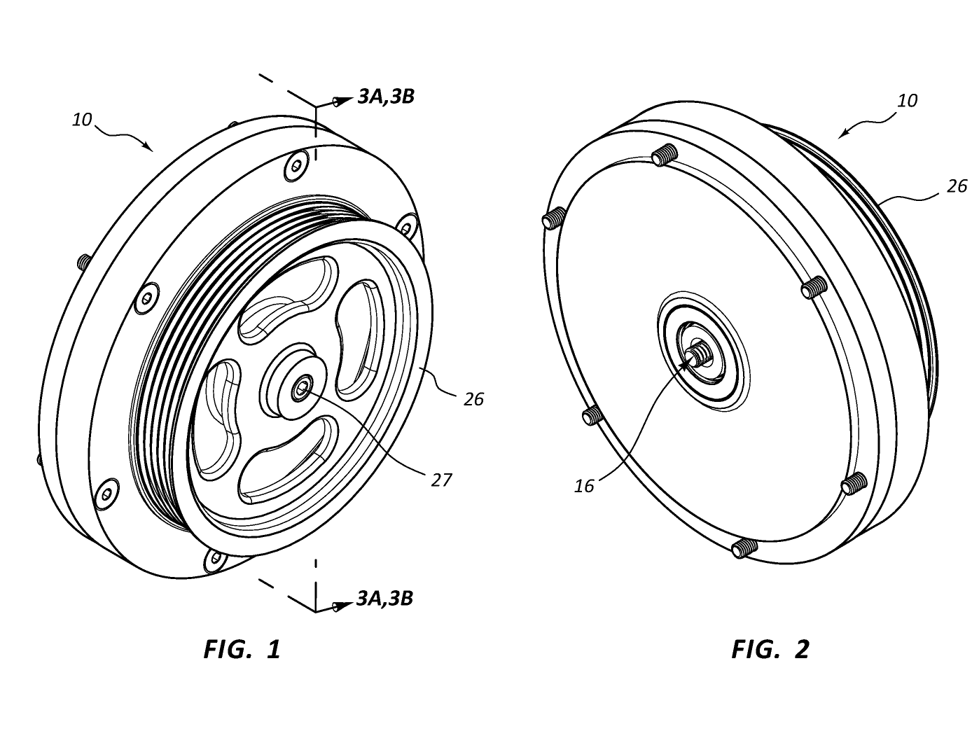

Referring now to FIGS. 1-4A, an example clutch assembly 10 implementing rheological features is shown and described. The clutch assembly 10 includes a housing 12, an input shaft 14, an output shaft 16, a pair of first friction plates 18A,B, a set of second friction plates 20A,B, a fluid activator 22, and an activator housing 23. The clutch assembly 10 includes a fluid 24 retained in housing 12 and surrounding at least portions of the first and second friction plates 18A,B and 20A,B. The clutch assembly 10 includes bearings 28, 29, which provide rotation of the clutch assembly 10 about the input and output shafts 14, 16.

The housing 12 includes first and second housing members 30, 32, which define a fluid space or cavity to receive the fluid 24. The input shaft 14 extends through the housing 12 and includes first and second ends 36, 38. The output shaft 16 also extends through the housing 12 and includes a shaft portion 40 and a carrier portion 42. The first friction plates 18A,B are mounted to the input shaft 14. The second friction plates 20A,B are mounted to the carrier portion of the output shaft 16. One of the input and output shafts 14, 16 are coupled to a torque source such as an electric motor or an engine driven motor.

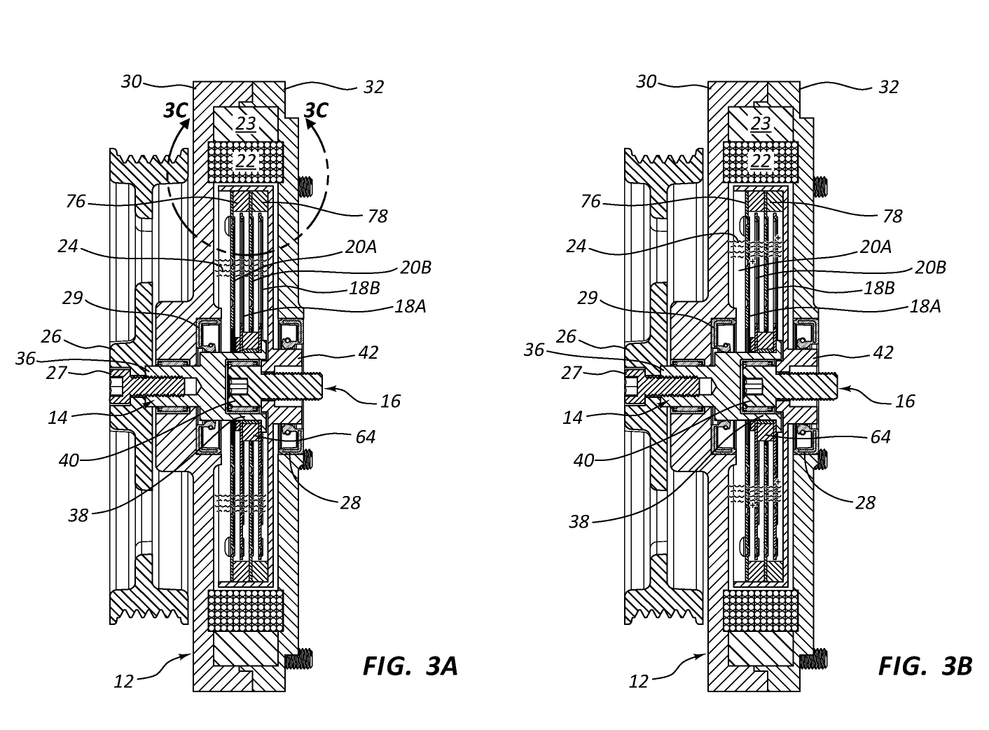

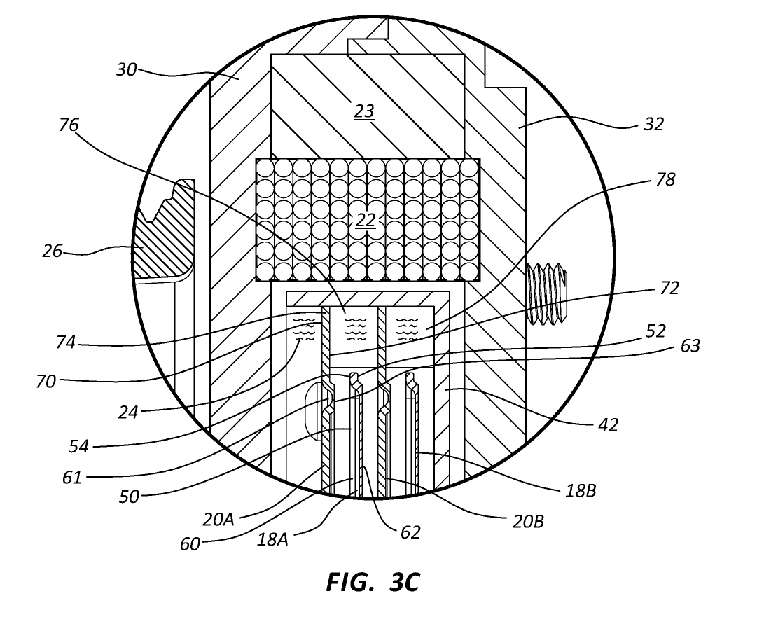

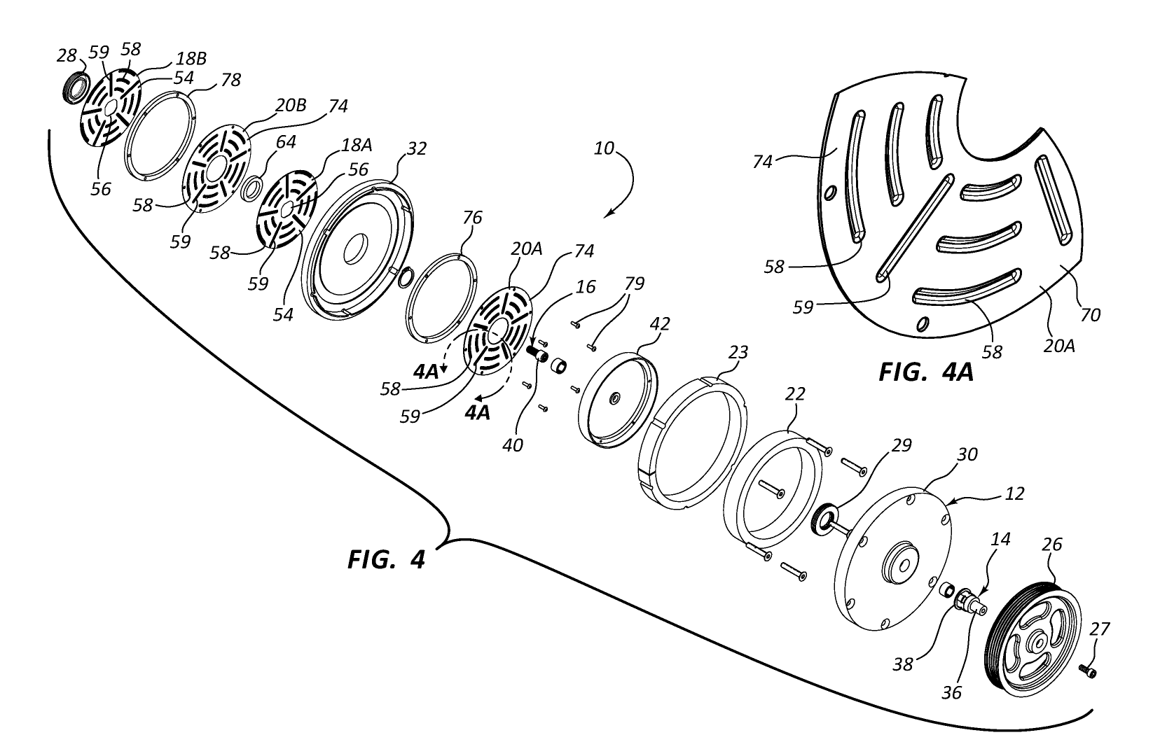

The first friction plates 18A,B each include first and second primary surfaces 50, 52 (see FIG. 3C), a peripheral portion 54, a central portion 56 (see FIG. 4), and a plurality of friction features. The friction features may include first and second friction features 58, 59 as shown in FIG. 4A. The first and second friction features 58, 59 may include a recess portion 60 and a protrusion portion 62 (see FIG. 3C). A spacer block 64 may be positioned between the first friction plates 18A,B to provide a fixed spacing therebetween (see FIGS. 3A and 3B). The spacing between the first friction plates 18A,B may be sufficient to position one of the second friction plates 20A,B between the first friction plates 18A,B without the second friction plates touching the first friction plates. The spacer block 64 may be connected to the first friction plates 18A,B adjacent to the central portion 56.

The first friction plates 18A,B may be directly connected to the input shaft 14 at the central portion 56. The central portion 56 may include keyed or splined features that assist in securing the first friction plates 18A,B to the input shaft 14. The input shaft 14 transfers torque to the first friction plates 18A,B to rotate the first friction plates.

The second friction plates 20A,B include first and second primary surfaces 70, 72, a peripheral portion 74, a pair of spacer blocks 76, 78, and a plurality of fasteners 79. A plurality of friction features may be included on at least one of the first and second primary surfaces 70, 72. The friction features may include first and second friction features 58, 59 as shown in FIG. 4A. The first and second friction features 58, 59 on the second friction plates 20A,B may include a recess portion 61 and a protrusion portion 63 (see FIG. 3C).

The spacer block 76 may be positioned between the second friction plates 20A,B. The second friction plates 20A,B are mounted to the shaft portion 40 of the output shaft 16 directly or indirectly via a coupling member. The spacer block 76 may be mounted to the second friction plates 20A,B at the peripheral portion 74. The spacer block 76 may be positioned radially outward from the first friction plates 18A,B.

In at least one example, at least one of the second friction plates 20A,B is mounted directly to the shaft portion 40 of the output shaft 16 with a splined connection. Other types of connections are possible for securing the second friction plates 20A,B to the output shaft 16.

The second friction plates 20A,B may be radially spaced outward from a portion of the input shaft 14 (see FIGS. 3A and 3B) and are free to rotate relative to the input shaft 14 of first friction plates 18A,B. The spacer block 76 may be used to suspend at least some of the second friction plates 20A,B spaced in between the first friction plates 18A,B. The fastener 79 may be used to secure the second friction plates 20A,B together with the spacer block 76 positioned therebetween.

The fluid activator 22 may be exposed to the fluid 24 positioned in the housing 12. In some examples, the fluid activator 22 comprises a magnet. In other examples, the fluid activator 22 comprises an electrode. Typically, when the fluid activator 22 is an electrode, the fluid activator 22 is directly exposed to the fluid 24. In embodiments that comprise a magnet for the fluid activator 22, the magnet may be physically spaced apart and isolated from the fluid 24 while being sufficiently close to impose a magnetic field on the fluid 24.

The fluid 24 may comprise a rheological fluid. In one example, the rheological fluid includes magnetic particles or particles that are energized by a magnetic or electrical field. The fluid 24 has a variable viscosity depending on operation of the fluid activator 22. In one example, operating the fluid activator 22 charges or energizes the fluid 24 to increase the viscosity of the fluid 24. The increased viscosity of the fluid 24 provides increased friction with the first and second friction plates 18A,B and 20A,B to create increased torque transfer between the input and output shafts 14, 16 via the first and second friction plates 18A,B and 20A,B.

The bearings 28, 29 may be interposed between the housing 12 and the input and output shafts 14, 16. The bearings 28, 29 may also provide a fluid-tight seal between the housing 12 and the input and output shafts 14, 16, respectively. At least FIGS. 3A and 3B show the bearing 29 interposed between the second friction plate 20A and the housing 12, wherein the second friction plate 20A is mounted directly to the output shaft 16 with a fluid-tight connection.

The first and second friction features 58, 59 formed in the first and second friction plates 18A,B and 20A,B may have various shapes, sizes, orientations, and arrangements on one of the first and second primary surfaces 50, 52 and 70, 72. The first and second friction features 58, 59 shown in FIGS. 4 and 4A are a combination of circumferentially and radially extending protrusions and recesses. For example, the first friction features 58 include a plurality of elongate, circumferentially spaced apart and radially spaced apart features. The first friction features 58 may be formed as a recess on the first primary surfaces 50, 70 and extend as protrusions on the second primary surfaces 52, 72. The length of each of the first friction features 58 increases moving radially outward from the central axis of the friction plates.

The second friction features 59 are elongate shaped structures extending radially outward from a central axis of the friction plates. The second friction features 59 are spaced apart circumferentially around the central axis. The second friction features 59 also may be formed as recesses along the first primary surfaces 50, 70 and extend as protrusions along the second primary surfaces 52, 72. The second friction features 59 may be interspaced circumferentially in between groups of the first friction features 58.

The first and second friction features 58, 59 provide increased surface friction as the first and second friction plates 18A,B and 20A,B move relative to each other with the fluid 24 spaced therebetween and in contact with the first and second primary surfaces 50, 52, and 70, 72. Typically, the first and second friction plates 18A,B and 20A,B are spaced apart in an axial direction a sufficient distance such that the first and second friction plates 18A,B and 20A,B, including the first and second friction features 58, 59 positioned on each of the friction plates, remain out of contact with each other at all times. The fluid 24, when energized by the fluid activator 22, may have a sufficiently high viscosity to transfer torque from the first friction plates 18A,B to the second friction plates 20A,B, or vice versa.

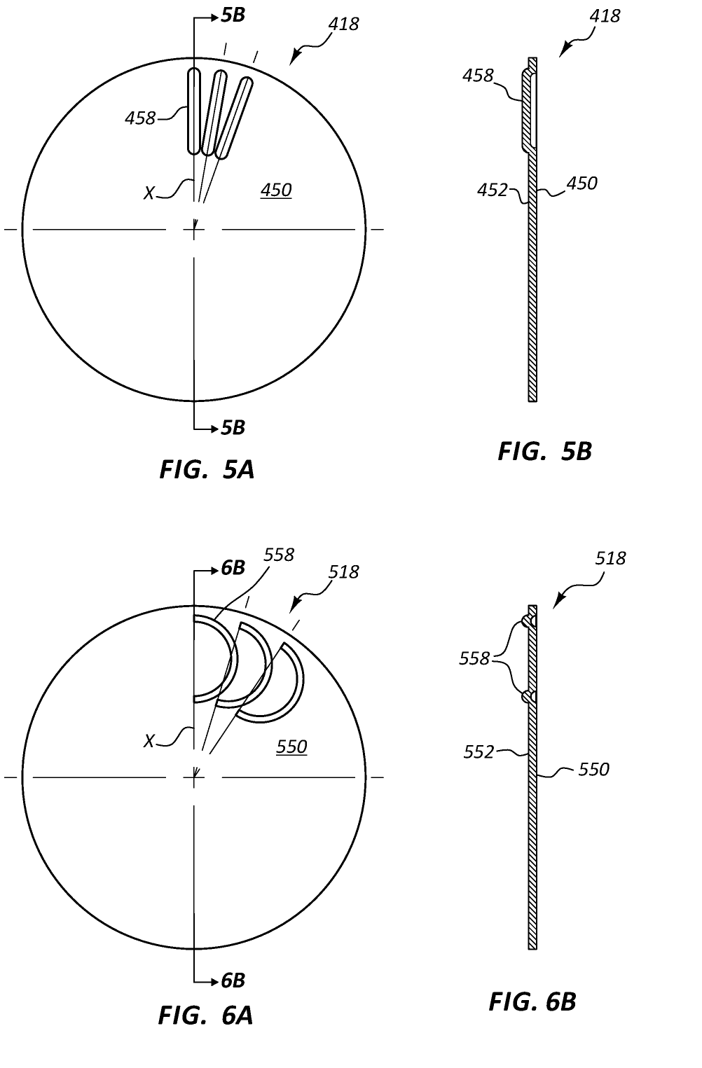

Referring now to FIGS. 5A-8B, further example friction feature configurations are shown and described. FIGS. 5A and 5B show an example first friction plate 418 having a plurality of friction features 458. The friction features 458 are elongate features aligned with radial axes X extending from a central point on the first friction plate 418. The first friction features 458 are positioned side-by-side. The friction features 458 may be formed as a recess along a first primary surface 450 and extend as a protrusion along a second primary surface 452 (see FIG. 5B).

FIGS. 6A and 6B show a friction plate 518 having a plurality of friction features 558. The friction features 558 have a scalloped shape, which may be referred to as a semi-circular shape. The friction features 558 may be formed as a recess along a first primary surface 550 and extend as a protrusion along a second primary surface 552 (see FIG. 6B). The friction features 558 may be aligned with a plurality of radial axes X extending from a central point on the friction plate 518. Other contoured shaped friction features may have a greater or smaller portion of a circle. Further, the friction features 558 may have different orientations relative to the radial axes X.

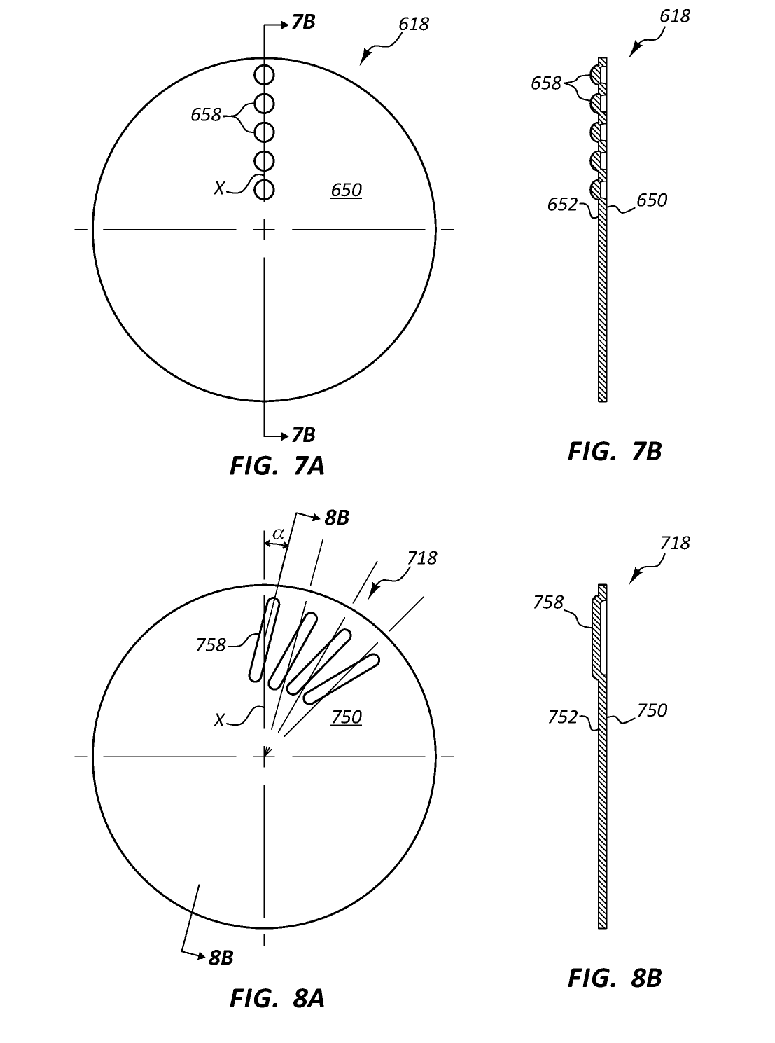

FIGS. 7A and 7B show another example friction plate 618 having a plurality of friction features 658. Friction features 658 are aligned along a radial axis X. The friction feature 658 may have a circular construction. The friction feature 658 may be formed as a recess along a first primary surface 650, and extend as a protrusion along a second primary surface 652 (see FIG. 7B). The size and relative spacing between the friction features 658 vary extending radially outward along the axis X. For example, a diameter of the friction feature 658 may be smaller at locations closer to a central point on the friction plate 618, and become larger in diameter at radially outward locations.

FIGS. 8A and 8B show another example friction plate 718 having a plurality of friction features 758. The friction features 758 have an elongate construction. The friction features 758 may be formed as a recess along a first primary surface 750 and may extend as a protrusion along a second primary surface 752 (see FIG. 8B). The friction features 758 may be arranged at an angle α relative to the radial axis X. The angle α may vary between 0° and about 90°.

The friction features shown in FIGS. 4-8B are merely exemplary of some of the different shapes, sizes, and orientation of various friction features that may be employed. While the friction features shown in FIGS. 4-8B are most easily formed by embossing. Other types of machining and forming techniques may be used to define friction features on either or both of the primary surfaces of the friction plate. The friction features may be provided in any desired combination of size, shape and orientation on either of the primary surfaces of the friction plate to tune an amount of friction for a specific application, thereby controlling the rate of torque throughput for the clutch assembly. The arrangement of friction features shown in FIGS. 4-8B may be duplicated on other portions of the first and second primary surfaces of the friction plates. The various friction features shown in FIGS. 4-8B may be used in combination with each other.

The first and second friction plates 18A,B and 20A,B are typically coupled or grounded to each other along either their inside diameter (see the first friction plates 18A,B) or their outside diameter (see the second friction plates 20A,B) and situated alternately in an interleaved arrangement relative to each other. A coupling or a grounding of the friction plates for direct connection to either the input or output shaft 14, 16 is not mandatory, but may be used in at least some embodiments to provide improved locking together of the friction plates. One advantage to such a configuration is the potential reduction of noise and wear.

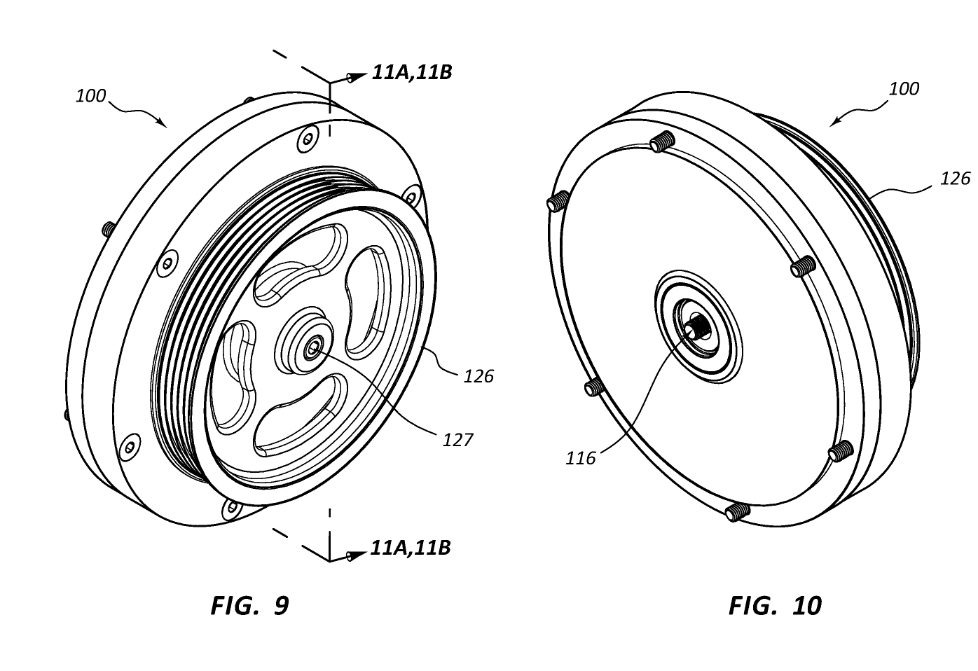

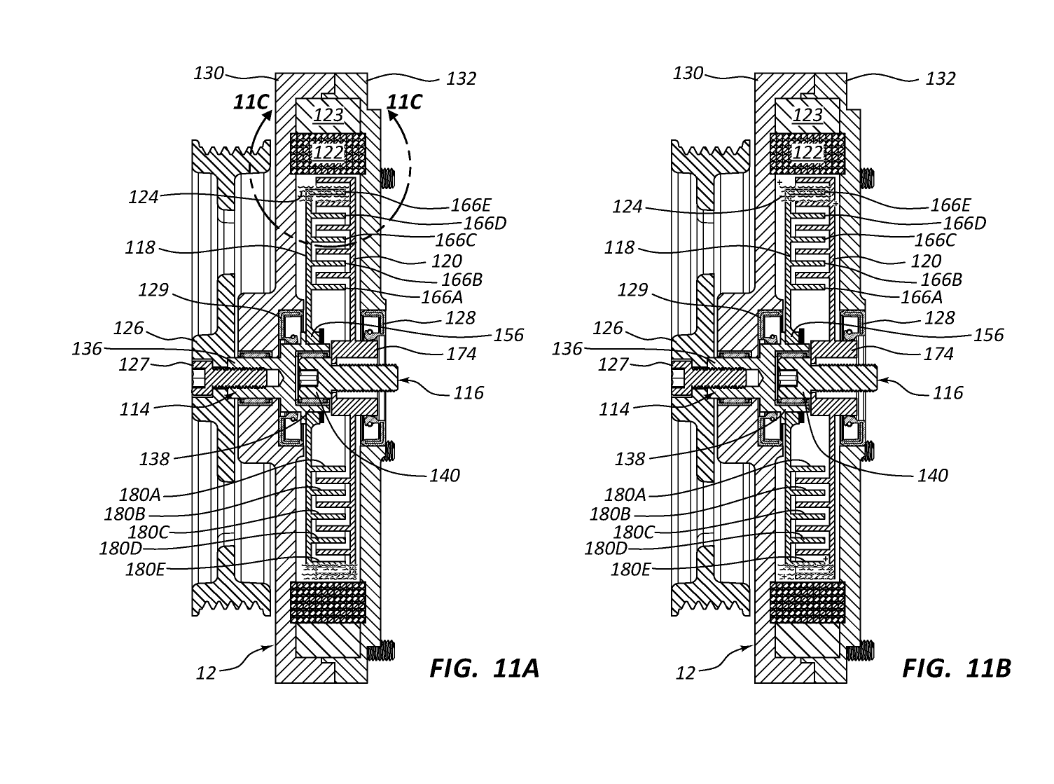

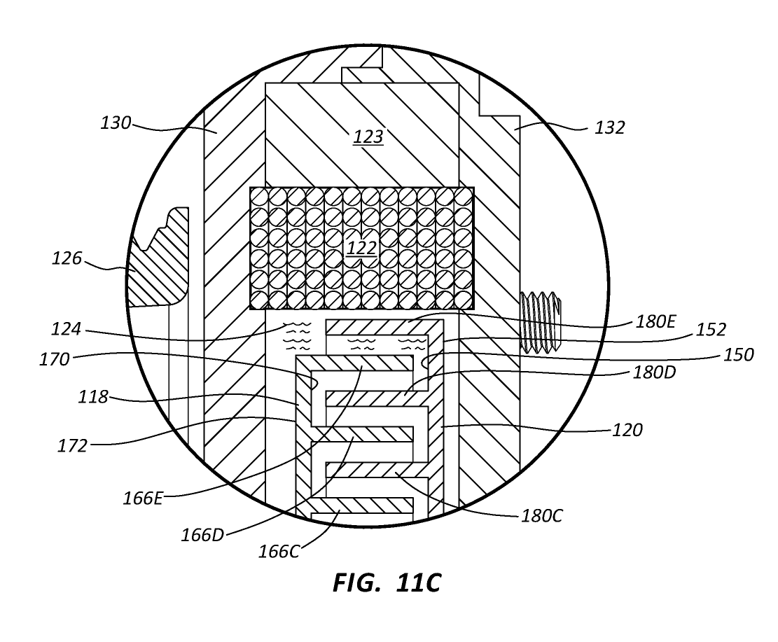

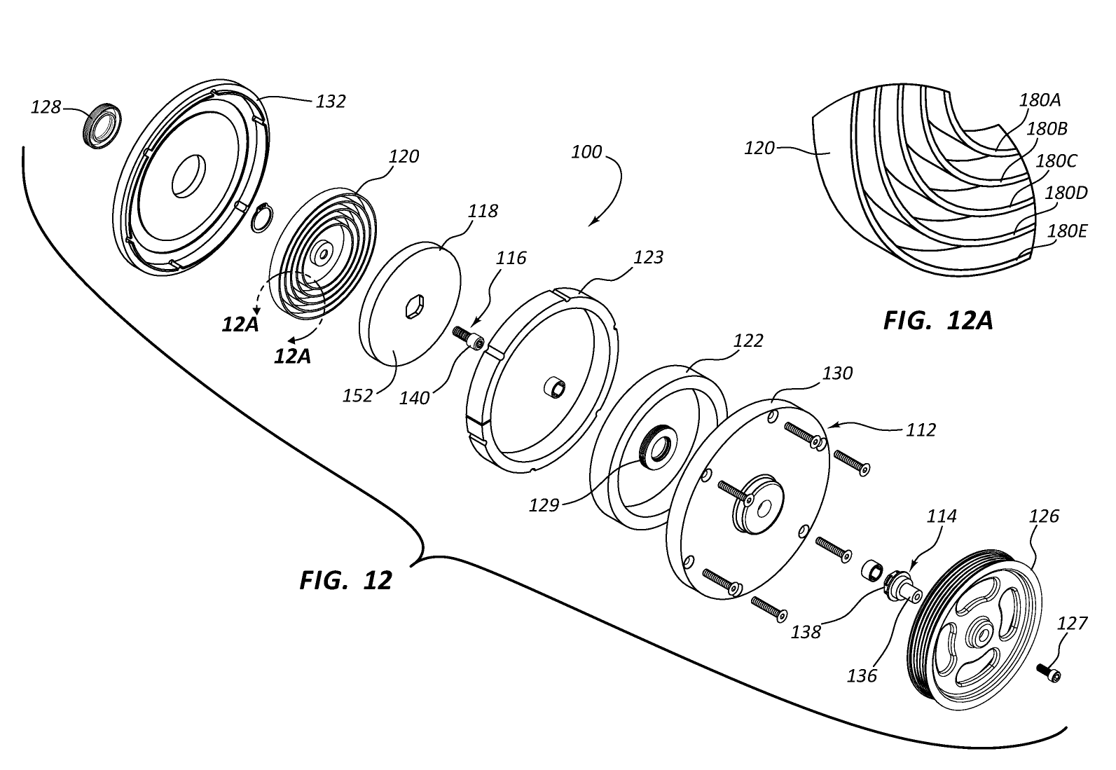

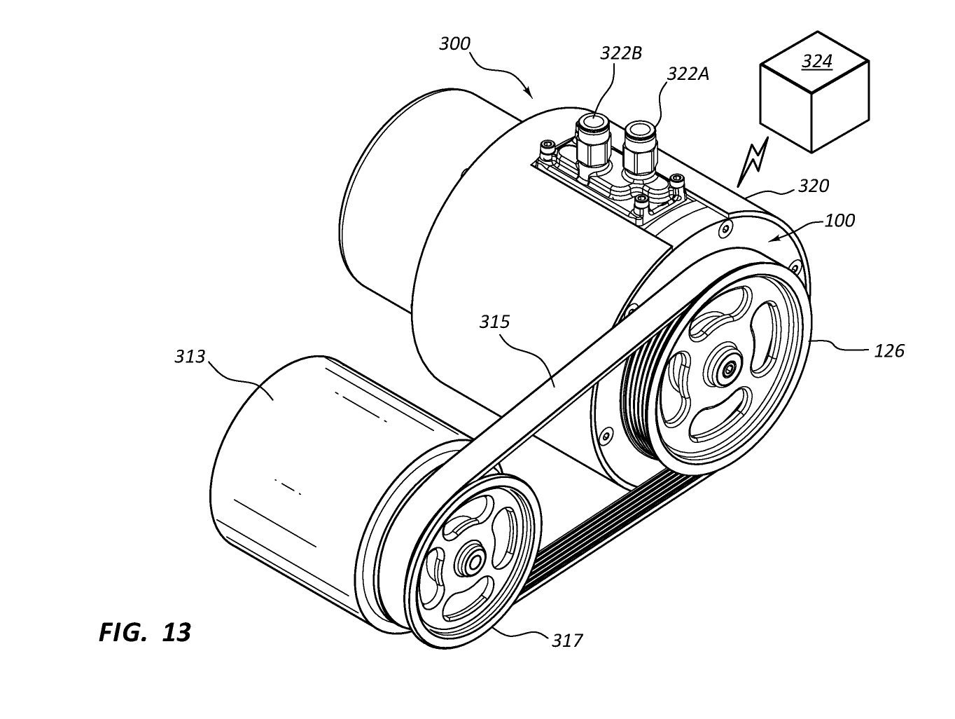

Referring now to FIGS. 9-12, another example clutch assembly 100 is shown having a concentric configuration. The clutch assembly 100 includes a housing 112, an input shaft 114, an output shaft 116, first and second friction plates 118, 120, a fluid activator 122, an activator housing 123, fluid 124, and bearings 128, 129. The housing 112 includes first and second housing members 130, 132, which together define a fluid space or cavity that holds the fluid 124. The input shaft 114 includes first and second ends 136, 138. The output shaft 116 includes a shaft portion 140. A first friction plate 118 is mounted directly to the input shaft 114. The second friction plate 120 is mounted directly to the output shaft 116. The fluid activator 122 is spaced radially outward from the first and second friction plates 118, 120 as shown in FIGS. 11A and 11B.

The first friction plate 118 includes first and second primary surfaces 150, 152 (see FIG. 11C), a central portion 156, and a plurality of first rings 166A-E extending from the first primary surface 150. The second friction plate 120 includes first and second primary surfaces 170, 172 (see FIG. 11C), a central portion 174, and a plurality of second rings 180A-E extending from the first primary surface 170 (see FIG. 11C). The first and second rings 166A-E and 180A-E are sized and arranged to concentrically fit within each other as shown in FIGS. 11A-11C. The fluid 24 may be positioned between the first and second friction plates 118, 120, including in between each of the first and second rings 166A-E and 180A-E. The first and second friction plates 118, 120 remain out of contact with each other during operation of the clutch assembly 100. The fluid 124, when energized by the fluid activator 122, provides increased friction that provides torque transfer from the first friction plate 118 to the second friction plate 120, or vice versa.

The first and second friction plates 118, 120 may include friction features formed in either or both of the first and second primary surfaces 150, 152 and 170, 172, or in any of the first and second rings 166A-E and 180A-E. The friction features may include recesses or protrusions such as those described above with reference to FIGS. 1-8B. When the clutch assembly 100 is assembled, the first and second rings 166A-E and 180A-E may be interleaved relative to each other. The height or width in which the first rings 166A-E extend from the first primary surface 150 and the second rings 180A-E extend from the first primary surface 170, as well as the spacing between the rings, and the number of rings may all be varied as desired to control the rate and intensity of torque throughput for the clutch assembly 100.

Determining a separation distance (e.g., gap) between the friction plates and associated friction features, whether the friction features of the first and second friction plates are arranged in parallel with each other (see FIGS. 1-4) or concentrically (see FIGS. 9-12), may be influenced at least in part by the rheological fluid quality and particle sizes as well as the design response time and torque capacity requirements.

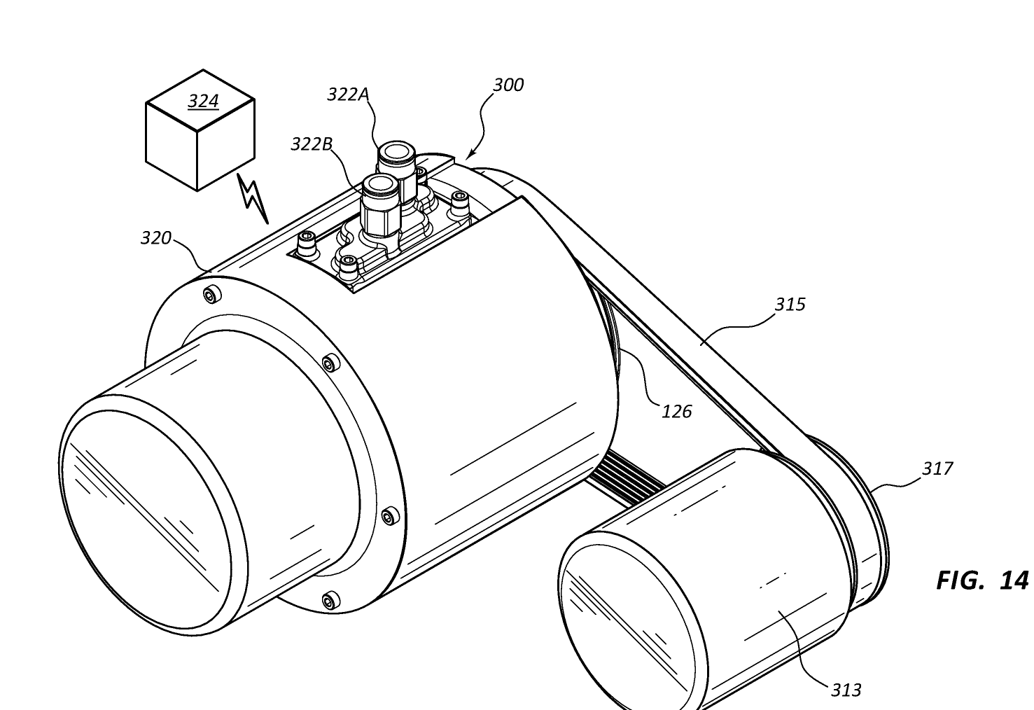

The clutch assembly 10 may further include a pulley 26 mounted with a pulley fastener 27 (see FIGS. 1 and 2), and the clutch assembly 100 may include a pulley 126 mounted with a pulley fastener 127 (see FIGS. 9 and 10). The pulleys 26, 126 may be coupled to a torque source such as an engine driven motor as shown in FIGS. 13 and 14. The engine driven motor 313 may include a pulley 317. A belt 315 or other torque transfer structure may couple the engine driven motor 313 to the pulley 26, 126. The pulley 26, 126 may be coupled to the input shaft 14, 114. The output shaft 16, 116 may drive a component such as an air compressor. The air compressor may also be separately driven by an additional torque source such as an electric motor. A controller may automatically switch between using the engine driven torque source 313 and the alternative torque source (e.g., electric motor) as a source of torque for operating the component (e.g., air compressor). The clutch may be selectively operated to use the engine driven torque source 313 as the source of torque after, for example, the engine driven motor 313 is operating at a threshold RPM.

When the first friction plates (also referred to as drive elements) are rotating and the rheological fluid is not energized, the low viscosity, off state, of the rheological fluid typically does not communicate sufficient torque to the second friction plate (also referred to as driven elements) to begin rotation (e.g., transfer torque). When the rheological fluid is energized, the viscosity increases and torque is transmitted through the viscous fluid into the second friction plate. The first and second friction plate features, such as the first and second friction features 58, 59 and the first and second rings 166A-E and 180A-E may provide increased surface area for rheological fluid coverage as well as physical flow resistance to enhance torque transfer.

Generally, in a parallel friction plate embodiment such as the one shown in FIGS. 1-4, the raised and recessed surface features of the friction plates may increase friction of the energized fluid to the friction plates thereby increasing the overall surface area and the amount of torque transferred. The surface features of the friction plates may be moderated to modify the flow of fluid between the friction plates such that variable engagement may be optimally controlled. Mechanically coupling at least some of the friction plates to each other along an outer perimeter thereof may eliminate or at least significantly reduce noise, vibration and harshness (NVH), chatter, fretting and wear commonly experienced in externally splined drive or driven elements of the rheological clutch.

In the concentric torque configuration of FIGS. 9-12, the first and second friction plates include ring features that are interleaved with each other, thus reducing component count and complexity in the assembly. The configuration of the concentric design may facilitate reduction in overall package length. The friction plates may include textured or constant surface features, embossments, rolled, cast or machine features. The friction features may be lateral or axial in their orientation. The friction features in the concentric designs of FIGS. 1-8A may increase the overall surface area of each facing surface, thus increasing the friction potential, torque transfer capacity, and controllability of the clutch.

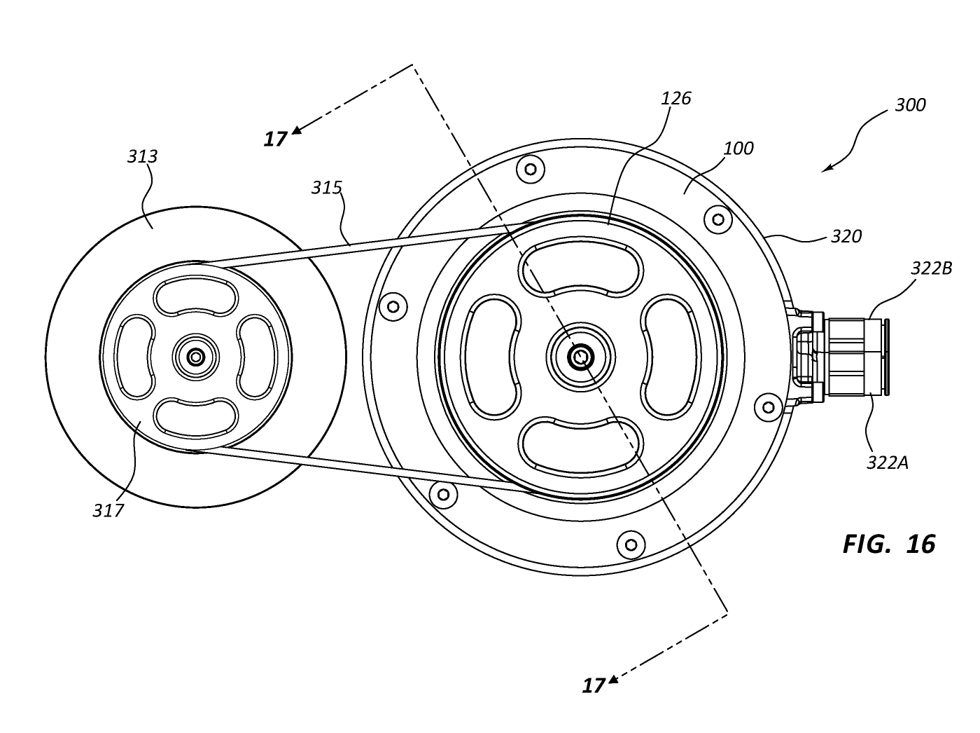

FIGS. 13-17 show an example compressor assembly 300 including the clutch assembly 100 and associated pulley 126. The compressor assembly 300 includes separate torque sources as an electric motor 314 positioned internally within a housing 320 of the compressor, and an engine driven motor 313 positioned external of the housing.

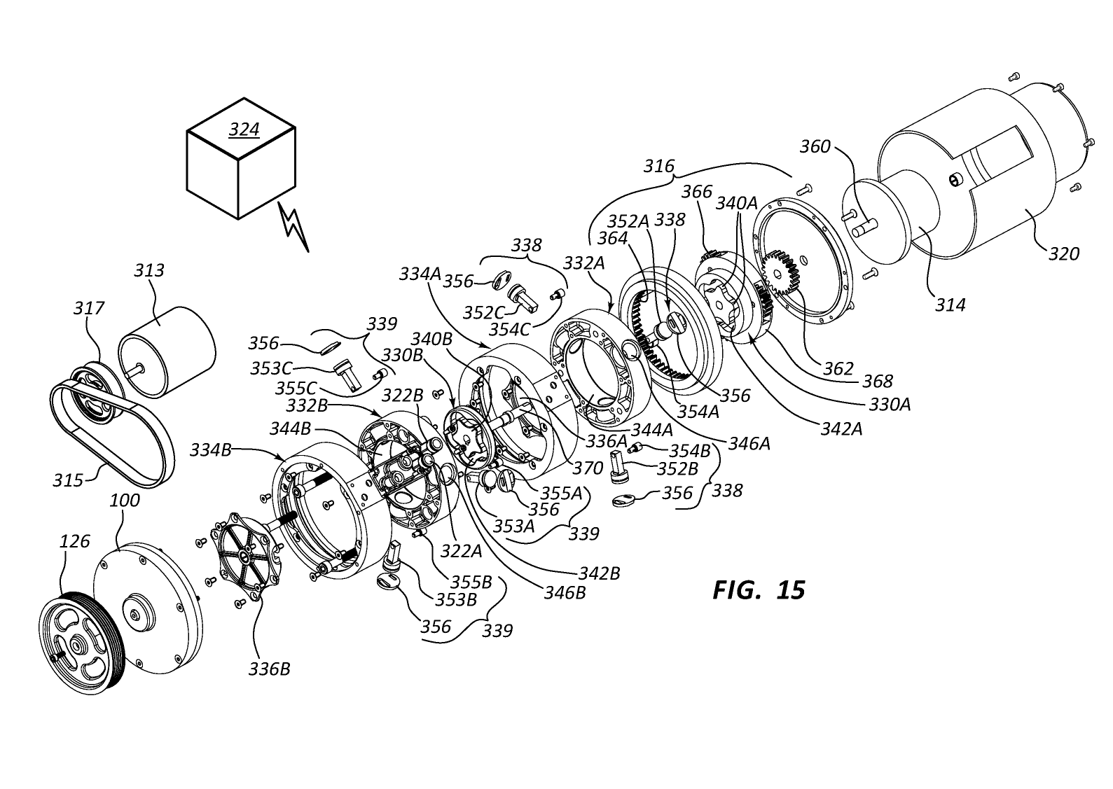

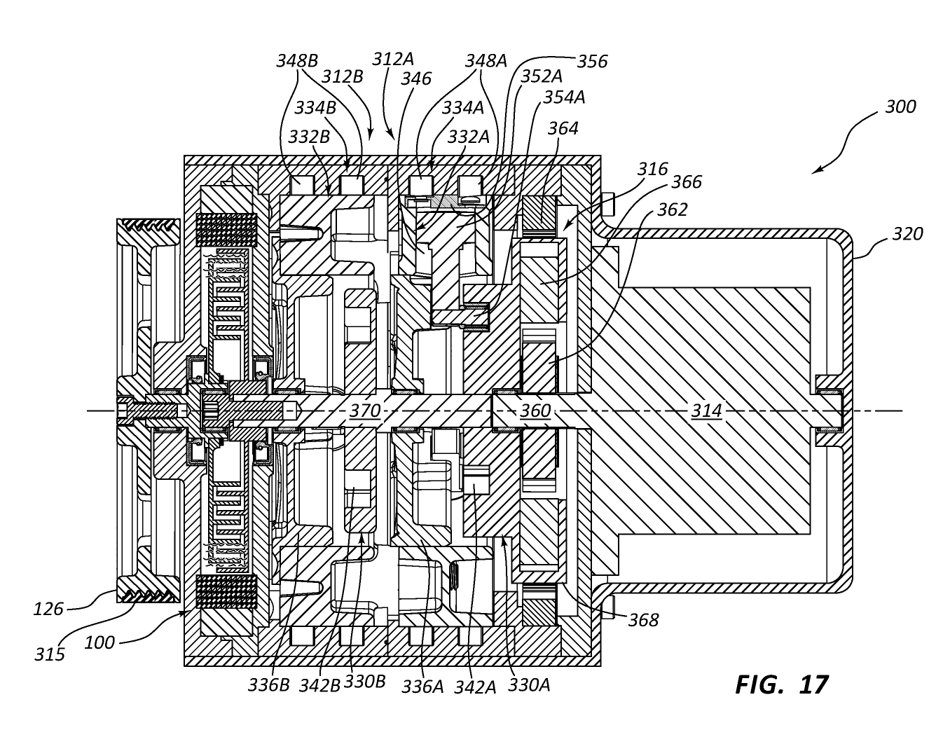

Referring now to FIGS. 13-17, and particularly the exploded view of FIG. 15 and the cross-section view of FIG. 17, a compressor assembly 300 is shown including a first compressor stage 312A, a second compressor stage 312B, an electric motor 314, a transmission 316, a pulley 126, a casing 320, inlet and outlet ports 322A, 322B, a controller 324, and the clutch assembly 100. The first and second compressor stages 312A, 312B are arranged in axial sequence with each other as shown in FIGS. 15 and 17. The drive plates of the first and second compressor stages 312A, 312B may rotate about a common axis and be driven by a common drive shaft. The drive shaft may be powered by the electric motor 314 or by a separate engine driven torque source 313 coupled to the drive shaft via the pulley 126 and clutch assembly 100.

The first compressor stage 312A includes a drive plate 330A, a piston housing 332A, a housing 334A, an end plate 336A, and a plurality of piston assemblies 338. The drive plate 330A includes a plurality of lobes 340A (e.g., five lobes), and a track 342A. The piston housing 332A includes a central bore 344A and a plurality of piston bores 346A (e.g., three piston bores). The housing 334A includes an air cavity 348A (see FIG. 17) and inlet and outlet openings coupled in flow communication with the inlet and outlet ports 322A, 322B. The piston assemblies 338 each include a plurality of pistons 352A-C, a plurality of piston followers 354A-C, and piston covers 356.

The second compressor stage 312B includes a drive plate 330B, a piston housing 332B, a housing 334B, an end plate 336B, and a plurality of piston assemblies 339. The drive plate 330B includes a plurality of lobes 340B (e.g., five lobes) and a track 342B. The piston housing 332B includes a central bore 344B and a plurality of piston bores 346B (e.g., three bores). The housing 334B includes an air cavity 348B (see FIG. 17) and inlet and outlet openings arranged in flow communication with the inlet and outlet ports 322A, 322B. The piston assemblies 339 each include a plurality of pistons 353A-C, a plurality of piston followers 355A-C, and a plurality of piston covers 356.

The electric motor 314 includes an output shaft 360 coupled to the transmission 316. The transmission 316 includes an input gear 362, a sun gear 364, a plurality of planet gears 366, and a gear housing 368. The transmission 316 is operably coupled to the drive plate 330A of first compressor stage 312A. The first and second compressor stages 312A, 312B are coupled together with a drive shaft 370 (see FIGS. 15 and 17). Rotating the drive plate 330A with the electric motor 314 and transmission 316 translates to concurrent rotation of the drive plate 330B.

The first and second compressor stages 312A, 312B, electric motor 314 and transmission 316 are positioned within the casing 320. The clutch 100 is interposed between the pulley 126 and the second compressor stage 312B, as shown in FIG. 17. The controller 324 may monitor various parameters such as an engine speed of an engine utilizing compressed air from compressor assembly 300, a rotation speed of pulley 126, and operation of electric motor 314 to determine when to shut off the electric motor 314 and begin using the engine driven torque source 313 to power the first and second compressor stages 312A, 312B. The controller 324 may activate the fluid activator 122 of the clutch assembly 100 to provide transfer of torque from the engine drive torque source 313, through the clutch assembly 100, and to the first and second compressor stages 312A, 312B.

The preceding description has been presented only to illustrate and describe certain aspects, embodiments, and examples of the principles claimed below. It is not intended to be exhaustive or to limit the described principles to any precise form disclosed. Many modifications and variations are possible in light of the above disclosure. Such modifications are contemplated by the inventor and within the scope of the claims. The scope of the principles described is defined by the following claims.

1. A clutch assembly, comprising:
an input shaft;
an output shaft;
a plurality of first friction plates mounted to the input shaft;
a plurality of second friction plates mounted to the output shaft and spaced apart from and always out of contact with the a plurality of first friction plates;
a rheological fluid positioned between the plurality of first friction plates and the plurality of second friction plates;
a fluid activator configured to increase a viscosity of the rheological fluid to provide increased torque transfer from the plurality of first friction plates to the plurality of second friction plates.

2. The clutch assembly of claim 1, further comprising a housing having an internal cavity, the plurality of first friction plates, plurality of second friction plates, and rheological fluid are positioned in the internal cavity.

3. The clutch assembly of claim 1, wherein the plurality of first friction plates and at least one second friction plate comprise a plurality of surface friction features.

4. The clutch assembly of claim 3, wherein the plurality of surface friction features comprise a plurality of projections.

5. The clutch assembly of claim 3, wherein the plurality of surface friction features comprise a plurality of recesses.

6. The clutch assembly of claim 3, wherein the plurality of surface friction features comprise a plurality of concentric rings.

7. The clutch assembly of claim 3, wherein the plurality of surface friction features are arranged symmetrically relative to each other on a given friction plate.

8. The clutch assembly of claim 3, wherein the plurality of surface friction features are spaced apart circumferentially and radially on at least some of the first and second friction plates.

9. The clutch assembly of claim 3, wherein the plurality of surface friction features are formed by at least one of embossing, rolling, casting and machining.

10. The clutch assembly of claim 3, wherein the plurality of surface friction features increase a surface area of the plurality of first friction plates and the plurality of second friction plates.

11. The clutch assembly of claim 1, wherein the fluid activator comprises a magnet, and the rheological fluid includes a plurality of magnetic particles.

12. The clutch assembly of claim 1, wherein the fluid activator comprises an electrode configured to electrically charge the rheological fluid.

13. The clutch assembly of claim 1, wherein the plurality of first friction plates includes a plurality of first friction plates grounded together along peripheral edges thereof.

14. The clutch assembly of claim 1, wherein the plurality of first friction plates is connected to the input shaft with a splined connection, and the plurality of second friction plates is connected to the output shaft with a splined connection.

15. A clutch assembly, comprising:
a plurality of first friction plates each having a first primary surface and a plurality of first friction features formed in the first primary surface;
a plurality of second friction plates each having a second primary surface and a plurality of second friction features formed in the second primary surface, a space being defined between the first and second primary surfaces, the plurality of first friction plates always being out of contact with the plurality of second friction plates;
a volume of fluid retained in the space and having a variable viscosity, wherein the volume of fluid, when energized, increases torque transfer from the plurality of first friction plates to the plurality of second friction plates.

16. The clutch assembly of claim 15, further comprising one of a magnet and an electrode configured to energize the volume of fluid.

17. (canceled)

18. The clutch assembly of claim 15, wherein the plurality of second friction plates are interposed between the plurality of first friction plates.

19. The clutch assembly of claim 15, further comprising an input shaft connected to the plurality of first friction plates and configured to be coupled to a first torque source, and an output shaft connected to the plurality of second friction plates and configured to be coupled to a second torque source.

20. A method of controlling torque transfer, comprising:
providing a clutch assembly having input and output shafts, a plurality of first friction plates connected to the input shaft, a plurality of second friction plates connected to the output shaft and spaced apart from and always out of contact with the plurality of first friction plates, and a rheological fluid positioned between the plurality of first friction plates and the plurality of second friction plates;
rotating the plurality of first friction plates relative to the plurality of second friction plates;
energizing the rheological fluid to increase a viscosity of the rheological fluid to increase torque transfer from the input shaft to the output shaft.

21. The method of claim 20, wherein the plurality of first friction plates and the plurality of second friction plates include a plurality of friction features configured to create increased surface friction with the rheological fluid.

22. The method of claim 20, further comprising providing at least one of a magnet and an electrode, and energizing the rheological fluid includes activating the magnet or electrode.

23. The method of claim 20, further comprising providing a torque source coupled to the input shaft, and a compressor coupled to the output shaft, operating the torque source, and energizing the rheological fluid to transfer torque from the torque source to the output shaft to apply torque to the compressor.

24. The method of claim 20, further comprising arranging the plurality of first friction plates and plurality of second friction plates radially and concentrically with the plurality of second friction plates interposed between the plurality of first friction plates.
